(19) United States
(12) Patent Application Publication
(10) Pub. No.: US 2023/0138991 A1
(43) Pub. Date: May 4, 2023

(54) MEMS MICROPHONE INCLUDING DIAPHRAGM

(71) Applicant: DB HITEK CO., LTD., Seoul (KR)

(72) Inventor: Min Hyun JUNG, Chungcheongbuk-do (KR)

(21) Appl. No.: 18/050,704

(22) Filed: Oct. 28, 2022

(30) Foreign Application Priority Data
Oct. 28, 2021 (KR) 10-2021-0145653

(51) Int. Cl. H04R 19/04; H04R 7/02

(52) U.S. Cl. CPC H04R 19/04; H04R 7/02; H04R 2201/003

(57) ABSTRACT

A MEMS microphone includes a substrate having a cavity, a diaphragm disposed above the substrate to correspond to the cavity, and a back plate disposed above the diaphragm. The diaphragm has a plurality of ventilation holes, each of the ventilation holes includes a plurality of slits, and the slits extend in a radial direction from a center of the each of the ventilation holes.

### CROSS-REFERENCE TO RELATED APPLICATION

This application claims the priority benefit of Korean Patent Application No. 10-2021-0145653, filed on Oct. 28, 2021, and all the benefits accruing therefrom under 35 U.S.C. § 119, the contents of which are incorporated by reference in their entirety.

### TECHNICAL FIELD

The present disclosure relates to a MEMS (Micro Electro Mechanical System) microphone. More specifically, the present disclosure relates to a MEMS microphone capable of converting a sound into an acoustic signal using a diaphragm configured to be vibrated by a sound pressure.

### BACKGROUND

A MEMS microphone may be used to convert a sound into an acoustic signal and may be manufactured by a MEMS technology. For example, the MEMS microphone may include a diaphragm disposed above a substrate and a back plate disposed above the diaphragm. The diaphragm and the back plate may be supported by a plurality of anchors on the substrate, and a predetermined air gap may be provided between the diaphragm and the back plate.

The diaphragm may include a lower conductive layer used as a lower electrode, and the back plate may include an upper conductive layer used as an upper electrode, and an insulating layer formed on the upper conductive layer to support the upper conductive layer. The diaphragm may be vibrated by an applied sound pressure, whereby the air gap between the diaphragm and the back plate may be changed. Further, a capacitance between the diaphragm and the back plate may be changed by the change in the air gap, and the acoustic signal may be detected from the change in the capacitance.

The diaphragm may have a plurality of ventilation holes, and the back plate may have a plurality of air holes. After the MEMS microphone is manufactured, an air blowing test may be performed. Air may be sprayed toward the diaphragm while performing the air blowing test, and the air may pass through the ventilation holes and the air holes.

Particularly, when increasing the size and number of the ventilation holes to pass the air blowing test, the sensitivity of the MEMS microphone may be deteriorated. Contrary to the above, when reducing the size and number of the ventilation holes, the diaphragm may be damaged while performing the air blowing test.

### SUMMARY

The present disclosure provides a MEMS microphone including an improved diaphragm to solve the above problems.

In accordance with an aspect of the present disclosure, a MEMS microphone may include a substrate having a cavity, a diaphragm disposed above the substrate to correspond to the cavity, and a back plate disposed above the diaphragm. Particularly, the diaphragm may have a plurality of ventilation holes, each of the ventilation holes may include a plurality of slits, and the slits may extend in a radial direction from a center of the each of the ventilation holes.

In accordance with some embodiments of the present disclosure, when air pressure is applied to the diaphragm, portions of the diaphragm between the slits may be bent by the air pressure so that a size of the ventilation holes is increased.

In accordance with some embodiments of the present disclosure, each of the ventilation holes may further include a circular central hole, and the slits may extend in the radial direction from the circular central hole.

In accordance with some embodiments of the present disclosure, the slits may have a triangular pyramid shape that gradually decreases in a width in the radial direction.

In accordance with some embodiments of the present disclosure, the slits may have a linear shape extending in the radial direction.

In accordance with some embodiments of the present disclosure, each of the ventilation holes may further include end holes respectively connected to end portions of the slits.

In accordance with some embodiments of the present disclosure, each of the ventilation holes may further include second slits respectively connected to end portions of the slits.

In accordance with some embodiments of the present disclosure, the second slits may have an arc shape, and the end portions of the slits may be respectively connected to central portions of the second slits.

In accordance with another aspect of the present disclosure, a MEMS microphone may include a substrate comprising a vibration area, a support area surrounding the vibration area, and a periphery area surrounding the support area, and having a cavity formed through the vibration area, a diaphragm disposed above the substrate to correspond to the cavity and having a plurality of ventilation holes, and a back plate disposed above the diaphragm and having a plurality of air holes. Particularly, each of the ventilation holes may include a circular central hole and a plurality of slits extending in a radial direction from the circular central hole.

In accordance with some embodiments of the present disclosure, the slits may have a triangular pyramid shape that gradually decreases in a width in the radial direction.

In accordance with some embodiments of the present disclosure, the slits may have a linear shape extending in the radial direction.

In accordance with some embodiments of the present disclosure, each of the ventilation holes may further include end holes respectively connected to end portions of the slits.

In accordance with some embodiments of the present disclosure, each of the ventilation holes may further include second slits respectively connected to end portions of the slits.

In accordance with some embodiments of the present disclosure, the second slits may have an arc shape, and the end portions of the slits may be respectively connected to central portions of the second slits.

In accordance with some embodiments of the present disclosure, the diaphragm may include a first electrode layer having a disk shape, a ventilation region configured to surround the first electrode layer and through which the ventilation holes are formed, and a first anchor portion configured to surround the ventilation region and configured to fix the diaphragm on the substrate.

In accordance with some embodiments of the present disclosure, the first anchor portion may be formed on the support area of the substrate.

In accordance with some embodiments of the present disclosure, the back plate may include a second electrode layer disposed above the first electrode layer to correspond to the first electrode layer, and a support layer formed on the second electrode layer and configured to support the second electrode layer. In such case, the support layer may include a second anchor portion configured to fix the support layer on the substrate.

In accordance with some embodiments of the present disclosure, the second anchor portion may be configured to surround the first anchor portion and may be formed on the support area of the substrate.

In accordance with some embodiments of the present disclosure, the MEMS microphone may further include a first insulating layer formed on the periphery area of the substrate, a first electrode pad formed on the first insulating layer and electrically connected to the first electrode layer, a second insulating layer formed on the first insulating layer and the first electrode pad, and a second electrode pad formed on the second insulating layer and electrically connected to the second electrode layer.

In accordance with some embodiments of the present disclosure, the MEMS microphone may further include a first bonding pad formed on the first electrode pad, and a second bonding pad formed on the second electrode pad. In such case, an edge portion of the support layer may be formed on the second insulating layer, the first bonding pad may be connected to the first electrode pad through the edge portion of the support layer and the second insulating layer, and the second bonding pad may be connected to the second electrode pad through the edge portion of the support layer.

In accordance with the embodiments of the present disclosure as described above, the slits may be opened when the air pressure is applied to the diaphragm. Thus, damage to the diaphragm may be prevented while the air blowing test is performed. Further, it is not necessary to increase the size and number of the ventilation holes to pass the air blowing test. Particularly, the slits may be opened only when the air pressure is applied to the diaphragm, and accordingly, it is possible to prevent the sensitivity of the MEMS microphone from being deteriorated.

The above summary of the present disclosure is not intended to describe each illustrated embodiment or every implementation of the present disclosure. The detailed description and claims that follow more particularly exemplify these embodiments.

### BRIEF DESCRIPTION OF THE DRAWINGS

Embodiments can be understood in more detail from the following description taken in conjunction with the accompanying drawings, in which:

FIG. 1 is a schematic plan view illustrating a MEMS microphone in accordance with an embodiment of the present disclosure;

FIG. 2 is a schematic cross-sectional view taken along a line I — I′ as shown in FIG. 1;

FIG. 3 is a schematic enlarged plan view illustrating a ventilation hole as shown in FIG. 1;

FIGS. 4 to 9 are schematic enlarged plan views illustrating other examples of the ventilation hole as shown in FIG. 3; and

FIGS. 10 to 22 are schematic cross-sectional views illustrating a method of manufacturing the MEMS microphone as shown in FIGS. 1 and 2.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Hereinafter, embodiments of the present invention are described in more detail with reference to the accompanying drawings. However, the present invention is not limited to the embodiments described below and is implemented in various other forms. Embodiments below are not provided to fully complete the present invention but rather are provided to fully convey the range of the present invention to those skilled in the art.

In the specification, when one component is referred to as being on or connected to another component or layer, it can be directly on or connected to the other component or layer, or an intervening component or layer may also be present.

Unlike this, it will be understood that when one component is referred to as directly being on or directly connected to another component or layer, it means that no intervening component is present. Also, though terms like a first, a second, and a third are used to describe various regions and layers in various embodiments of the present invention, the regions and the layers are not limited to these terms.

Terminologies used below are used to merely describe specific embodiments, but do not limit the present invention. Additionally, unless otherwise defined here, all the terms including technical or scientific terms, may have the same meaning that is generally understood by those skilled in the art.

Embodiments of the present invention are described with reference to schematic drawings of ideal embodiments. Accordingly, changes in manufacturing methods and/or allowable errors may be expected from the forms of the drawings. Accordingly, embodiments of the present invention are not described being limited to the specific forms or areas in the drawings, and include the deviations of the forms. The areas may be entirely schematic, and their forms may not describe or depict accurate forms or structures in any given area, and are not intended to limit the scope of the present invention.

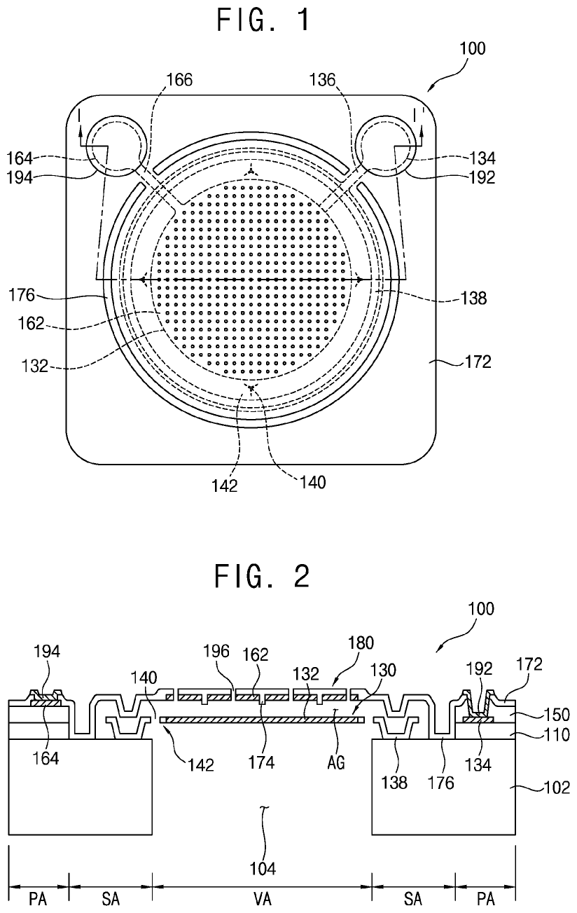

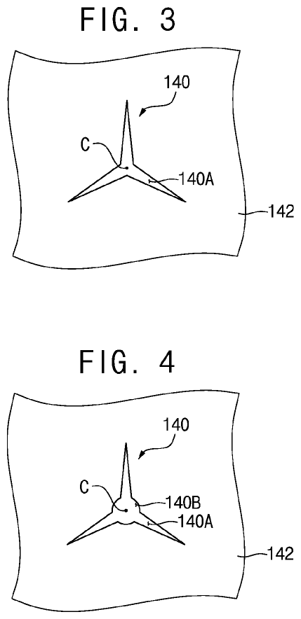

FIG. 1 is a schematic plan view illustrating a MEMS microphone in accordance with an embodiment of the present disclosure, and FIG. 2 is a schematic cross-sectional view taken along a line I-I′ as shown in FIG. 1. FIG. 3 is a schematic enlarged plan view illustrating a ventilation hole as shown in FIG. 1, and FIGS. 4 to 9 are schematic enlarged plan views illustrating another example of the ventilation hole as shown in FIG. 3.

Referring to FIGS. 1 and 2, a MEMS microphone 100, in accordance with an embodiment of the present disclosure, may include a substrate 102 having a cavity 104, a diaphragm 130 disposed above the substrate 102 to correspond to the cavity 104, and a back plate 180 disposed above the diaphragm 130.

For example, the substrate 102 may be a single-crystal silicon substrate, and may include a vibration area (VA), a support area (SA) surrounding the vibration area (VA), and a periphery area (PA) surrounding the support area (SA). In such case, the cavity 104 may be formed to pass through the vibration area (VA), and the diaphragm 130 may be exposed through the cavity 104.

In accordance with an embodiment of the present disclosure, the diaphragm 130 may be spaced apart from the substrate 102 to be vibrated by an applied sound pressure. For example, the diaphragm 130 may include a first electrode layer 132 made of a conductive material and having a disk shape, and a first anchor portion 138 configured to surround the first electrode layer 132 and to fix the first electrode layer 132 on the substrate 102. For example, the first electrode layer 132 may be made of polysilicon doped with impurities, and the first anchor portion 138 may be made of undoped polysilicon. Further, the first anchor portion 138 may have a ring shape surrounding the first electrode layer 132 and may be formed on the support area (SA) of the substrate 102. In particular, the first electrode layer 132 may be disposed above the substrate 102 to face the cavity 104 as shown in FIG. 2.

Particularly, the diaphragm 130 may include a ventilation region 142 having a circular ring shape surrounding the first electrode layer 132. In such case, the first anchor portion 138 may have a circular ring shape surrounding the ventilation region 142. In accordance with an embodiment of the present disclosure, the diaphragm 130 may have a plurality of ventilation holes 140 formed to pass through the ventilation region 142.

Further, the diaphragm 130 may include a first electrode pad 134 electrically connected to the first electrode layer 132. For example, the first electrode pad 134 may be connected to the first electrode layer 132 by a first connection pattern 136 as shown in FIG. 1. In this case, the first electrode pad 134 and the first connection pattern 136 may be made of the same material as the first electrode layer 132.

The back plate 180 may include a support layer 172 made of an insulating material, and a second electrode layer 162 attached to a lower surface of the support layer 172 and made of a conductive material. In particular, the second electrode layer 162 may be disposed above the first electrode layer 132 to correspond to the first electrode layer 132, and may have a disk shape. For example, the back plate 180 may be disposed above the diaphragm 130 so that the second electrode layer 162 is spaced apart from the first electrode layer 132 by a predetermined distance. That is, a predetermined air gap (AG) may be provided between the first electrode layer 132 and the second electrode layer 162. For example, the second electrode layer 162 may be made of polysilicon doped with impurities, and the support layer 172 may be made of silicon nitride.

In addition, the back plate 180 may include a second anchor portion 176 for fixing the support layer 172 and the second electrode layer 162 on the substrate 102, and a second electrode pad 164 electrically connected to the second electrode layer 172. For example, as shown in FIG. 2, the second anchor portion 176 may be disposed on the support area (SA) of the substrate 102 and may be made of silicon nitride. The second electrode layer 162 and the second electrode pad 164 may be electrically connected by a second connection pattern 166 as shown in FIG. 1. Further, the second electrode pad 164 and the second connection pattern 166 may be formed of the same material as the second electrode layer 162.

The first anchor portion 138 may have a circular ring shape surrounding the cavity 104, and the second anchor portion 176 may have a circular ring shape surrounding the first anchor portion 138. For example, each of the first anchor part 138 and the second anchor part 176 may have a channel shape with an open top as shown in FIG. 2.

The ventilation region 142 may be disposed between the first electrode layer 132 and the first anchor portion 138, and the ventilation holes 140 may be connected to the air gap AG through the ventilation region 142. As shown in FIG. 1, four ventilation holes 140 are formed through the ventilation region 142, but the number of the ventilation holes 140 may be variously changed.

A first insulating layer 110 may be disposed on the periphery area (PA) of the substrate 102, and a second insulating layer 150 may be disposed on the first insulating layer 110. In this case, the first electrode pad 134 may be disposed on the first insulating layer 110, and the second electrode pad 164 may be disposed on the second insulating layer 150. For example, the first insulating layer 110 and the second insulating layer 150 may be made of silicon oxide, and may be formed to surround the second anchor portion 176.

A first bonding pad 192 may be disposed on the first electrode pad 134, and a second bonding pad 194 may be disposed on the second electrode pad 164. For example, an edge portion of the support layer 172 may be formed on the second insulating layer 150, the first bonding pad 192 may be connected to the first electrode pad 134 through the edge portion of the support layer 172 and the second insulating layer 150, and the second bonding pad 194 may be connected to the second electrode pad 164 through the edge portion of the support layer 172.

Specifically, a first contact hole (CH1; refer to FIG. 18) exposing the first electrode pad 134 may be formed through the edge portion of the support layer 172 and the second insulating layer 150, and the first bonding pad 192 may be formed in the first contact hole (CH1). Further, a second contact hole (CH2; refer to FIG. 18) exposing the second electrode pad 164 may be formed through the edge portion of the support layer 172, and the second bonding pad 194 may be formed in the second contact hole (CH2).

In addition, the support layer 172 may include protrusions 174 penetrating through the second electrode layer 162 and protruding toward the first electrode layer 132. The protrusions 174 may be made of the same material as the support layer 172, and may be used to prevent the first electrode layer 132 and the second electrode layer 162 from contacting each other.

Further, the back plate 180 may have a plurality of air holes 196 connected to the air gap (AG). The air holes 196 may be formed through the support layer 172 and the second electrode layer 162. For example, the air holes 196 may be disposed among the protrusions 174.

Referring to FIG. 3, each of the ventilation holes 140 may include a plurality of slits 140A. The slits 140A may extend in a radial direction from a center (C) of the each of the ventilation holes 140. Particularly, when air pressure is applied to the diaphragm 130, portions of the diaphragm 130 between the slits 140A may be bent by the air pressure so that a size of the ventilation holes 140 is increased. For example, when an air blowing test is performed, an air may be sprayed to the diaphragm 130, whereby an air pressure may be applied to the diaphragm 130. In particular, portions of the ventilation region 142 between the slits 140A may be bent by the air pressure, thereby opening the slits 140A. That is, the ventilation holes 140 may be expanded by the air pressure, and accordingly, the air may easily pass through the expanded ventilation holes 140.

As a result, damage to the diaphragm 130 may be prevented by the expanded ventilation holes 140 while the air blowing test is performed. In particular, the slits 140A may be opened only when the air pressure is applied to the diaphragm 130, and accordingly, the sensitivity of the MEMS microphone 100 may be prevented from being deteriorated. In addition, it is not necessary to increase the size and number of the ventilation holes 140, and accordingly, the noise of the MEMS microphone 100 may be reduced.

As an example, as shown in FIG. 3, each of the slits 140A may have a triangular pyramid shape that gradually decreases in a width in the radial direction, that is, in the extension direction of the slits 140A.

As another example, as shown in FIG. 4, each of the ventilation holes 140 may include a circular central hole 140B. In this case, the slits 140A may extend in the radial direction from the circular central hole 140B.

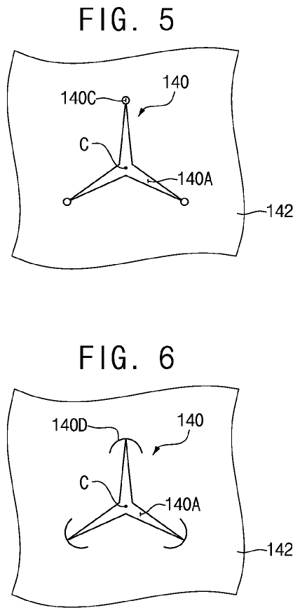

As still another example, as shown in FIG. 5, each of the ventilation holes 140 may include end holes 140C respectively connected to end portions of the slits 140A. In such case, the end holes 140C may be used to prevent stress from being concentrated at the end portions of the slits 140A.

As still another example, as shown in FIG. 6, each of the ventilation holes 140 may include second slits 140D respectively connected to end portions of the slits 140A. In such case, the second slits 140D may be used to prevent stress from being concentrated at the end portions of the slits 140A. For example, the second slits 140D may have an arc shape, and the end portions of the slits 140A may be respectively connected to central portions of the second slits 140D.

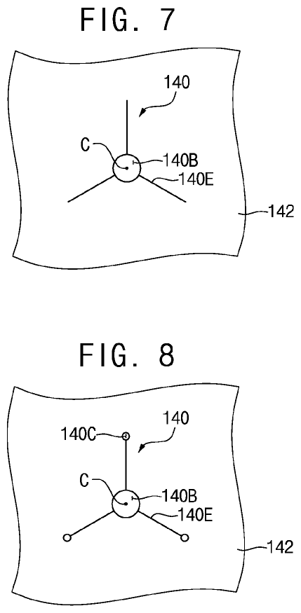

As still another example, as shown in FIG. 7, each of the ventilation holes 140 may include a circular central hole 140B and a plurality of slits 140E extending in a radial direction from the circular central hole 140B. In such case, the slits 140E may have a linear shape extending in the radial direction.

As still another example, as shown in FIG. 8, each of the ventilation holes 140 may include end holes 140C respectively connected to end portions of the slits 140E. In such case, the end holes 140C may be used to prevent stress from being concentrated at the end portions of the slits 140E.

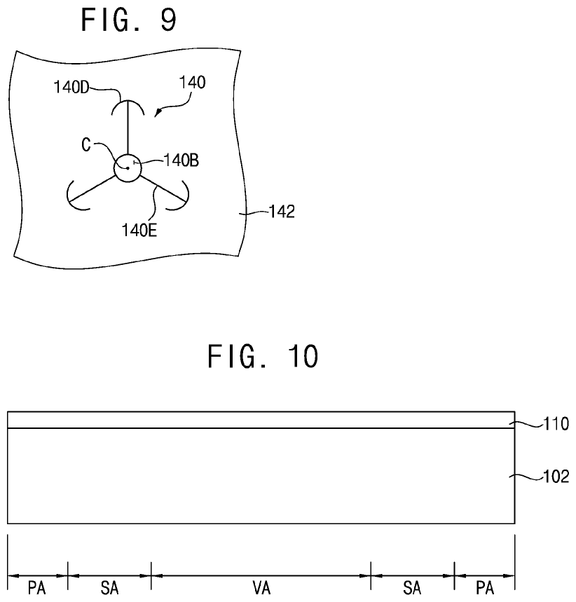

As still another example, as shown in FIG. 9, each of the ventilation holes 140 may include second slits 140D respectively connected to end portions of the slits 140E. In such case, the second slits 140D may be used to prevent stress from being concentrated at the end portions of the slits 140E. For example, the second slits 140D may have an arc shape, and the end portions of the slits 140E may be respectively connected to central portions of the second slits 140D.

FIGS. 10 to 22 are schematic cross-sectional views illustrating a method of manufacturing the MEMS microphone as shown in FIGS. 1 and 2.

Referring to FIG. 10, a first insulating layer 110 may be formed on a substrate 102. For example, the substrate 102 may be a silicon wafer, and the first insulating layer 110 may be made of an insulating material such as silicon oxide. The first insulating layer 110 may be formed conformally, that is, to have an approximately uniform thickness through a chemical vapor deposition process.

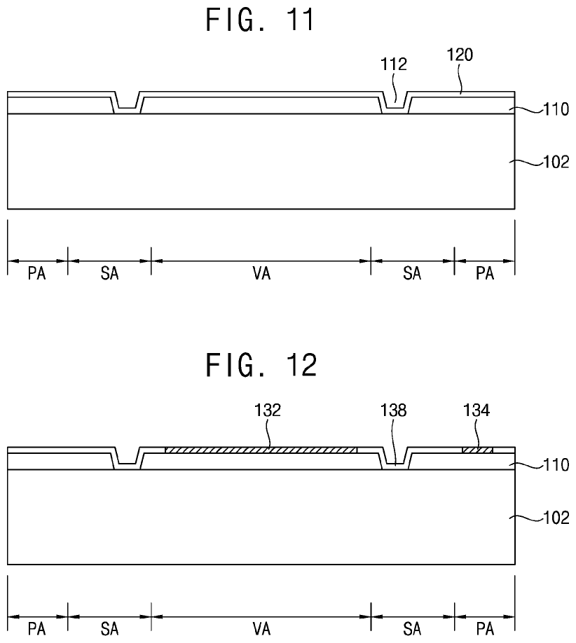

Referring to FIG. 11, the first insulating layer 110 may be patterned to form a first anchor channel 112 exposing a surface portion of the substrate 102. The substrate 102 may include a vibration area (VA), a support area (SA) surrounding the vibration area (VA), and a periphery area (PA) surrounding the support area (SA), and the first anchor channel 112 may be formed on the support area (SA). In particular, the first anchor channel 112 may have a circular ring shape surrounding the vibration region (VA). For example, after forming a photoresist pattern exposing a portion where the first anchor channel 112 is to be formed on the first insulating layer 110, an etching process using the photoresist pattern as an etching mask may be performed, whereby the first anchor channel 112 may be formed to expose a portion of the upper surface of the substrate 102.

After forming the first anchor channel 112, a first silicon layer 120 may be conformally formed on the first insulating layer 110 to have an approximately uniform thickness. For example, the first silicon layer 120 may be a polysilicon layer formed by a chemical vapor deposition process. In such case, a portion of the first silicon layer 120 formed in the first anchor channel 112 may be used as a first anchor portion 138 for fixing a diaphragm 130 to be formed subsequently on the substrate 102.

Referring to FIG. 12, an ion implantation process may be performed to form a portion of the first silicon layer 120 into a first electrode layer 132 having conductivity. Further, a first electrode pad 134 and a first connection pattern 136 (refer to FIG. 1) for connecting the first electrode layer 132 and the first electrode pad 134 may be formed in the first silicon layer 120 by the ion implantation process. For example, the first electrode layer 132 may have a disk shape and may be formed above the vibration area (VA). The first electrode pad 134 may be formed above the periphery area (PA).

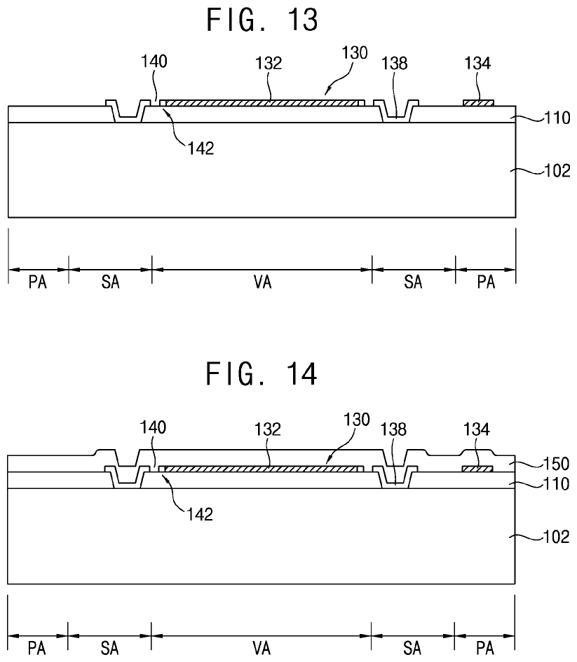

Referring to FIG. 13, the first silicon layer 120 may be patterned to form a diaphragm 130 including the first electrode layer 132, the first electrode pad 134, and the first connection pattern 136. In addition, a first anchor portion 138 for fixing the diaphragm 130 on the substrate 102 may be formed on a portion of the substrate 102 exposed by the first anchor channel 112.

Particularly, a plurality of ventilation holes 140 may be formed between the first electrode layer 132 and the first anchor portion 138. Specifically, a portion of the first silicon layer 120 between the first electrode layer 132 and the first anchor portion 138 may be used as a ventilation region 142, and the ventilation holes 140 may be formed to pass through the ventilation region 142. For example, the first electrode layer 132 may have a disk shape, and the ventilation region 142 may have a circular ring shape surrounding the first electrode layer 132.

For example, a photoresist pattern covering portions where the first electrode layer 132, the first electrode pad 134, the first connection pattern 136, and the first anchor portion 138 are to be formed may be formed on the first silicon layer 120, and then, an etching process using the photoresist pattern as an etching mask may be performed until the first insulating layer 110 is exposed. Further, the photoresist pattern may expose portions of the first silicon layer 120 where the ventilation holes 140 are to be formed, and the ventilation holes 140 may be formed by the etching process.

Referring to FIG. 14, a second insulating layer 150 may be formed on the first insulating layer 110 and the diaphragm 130. For example, the second insulating layer 150 may include silicon oxide, and may be formed conformally, that is, to have an approximately uniform thickness by a chemical vapor deposition process.

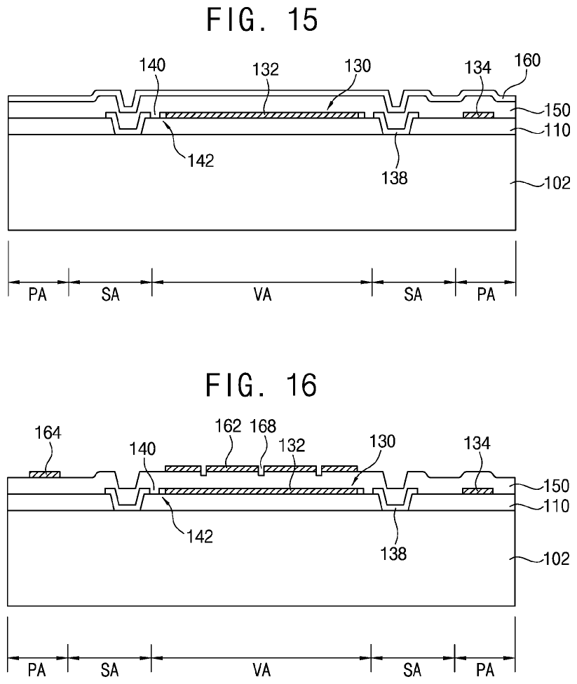

Referring to FIG. 15, a second silicon layer 160 may be conformally formed on the second insulating layer 150 to have an approximately uniform thickness. For example, the second silicon layer 160 may be a polysilicon layer formed by a chemical vapor deposition process. Subsequently, an ion implantation process may be performed to form the second silicon layer 160 into a conductive layer (not shown), that is, into a polysilicon layer doped with impurities.

Referring to FIG. 16, the conductive layer may be patterned to form a second electrode layer 162 corresponding to the first electrode layer 132, a second electrode pad 164, and a second connection pattern 166 (refer to FIG. 1) for connecting the second electrode layer 162 and the second electrode pad 164. That is, as shown in FIG. 16, remaining portions of the conductive layer excluding the second electrode layer 162, the second electrode pad 164, and the second connection pattern 166 may be removed. For example, a photoresist pattern may be formed on the conductive layer to cover regions where the second electrode layer 162, the second electrode pad 164, and the second connection pattern 166 are to be formed, and then, an etching process using the photoresist pattern as an etching mask may be performed until the second insulating layer 150 is exposed.

Then, a plurality of holes 168 for forming protrusions 174 (refer to FIG. 2) extending toward the first electrode layer 132 may be formed by removing portions of the second electrode layer 162 and the second insulating layer 150. The holes 168 may have a predetermined depth so as to extend through the second electrode layer 162 to a portion of the second insulating layer 150. For example, after forming a photoresist pattern exposing portions where the holes 168 are to be formed on the second electrode layer 162, an anisotropic etching process using the photoresist pattern as an etching mask may be performed for a predetermined time.

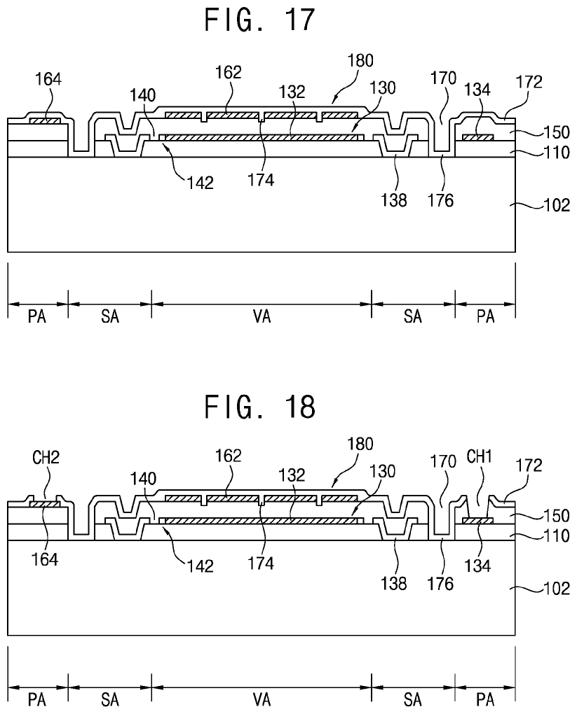

Referring to FIG. 17, a support layer 172 may be formed on the second insulating layer 150 and the second electrode layer 162. For example, the second insulating layer 150 and the first insulating layer 110 may be patterned to form a second anchor channel 170 having a circular ring shape surrounding the first anchor portion 138. For example, a photoresist pattern exposing portions where the second anchor channel 170 is to be formed may be formed on the second insulating layer 150, and then, an anisotropic etching process using the photoresist pattern as an etching mask may be performed until the upper surface of the substrate 102 is exposed.

After the second anchor channel 170 is formed, a support layer 172 may be conformally formed on the second electrode layer 162 and the second insulating layer 150 to have an approximately uniform thickness. As a result, a back plate 180 including the second electrode layer 162 and the support layer 172 may be formed above the substrate 102. For example, the support layer 172 may be a silicon nitride layer formed by a chemical vapor deposition process. In particular, the support layer 172 may be formed to fill the holes 168, whereby protrusions 174 extending downward from the support layer 172 through the second electrode layer 162 may be formed. In addition, a portion of the support layer 172 formed in the second anchor channel 170 may be used as a second anchor portion 176 for fixing the support layer 172 on the substrate 102.

Referring to FIG. 18, a first contact hole (CH1) exposing the first electrode pad 134 may be formed by patterning the support layer 172 and the second insulating layer 150. In addition, a second contact hole (CH2) exposing the second electrode pad 164 may be formed by patterning the support layer 172. For example, after forming a photoresist pattern exposing portions of the support layer 172 corresponding to the first electrode pad 134 and the second electrode pad 164 on the support layer 172, the first contact hole (CH1) and the second contact hole (CH2) may be formed by an anisotropic etching process using the photoresist pattern as an etching mask.

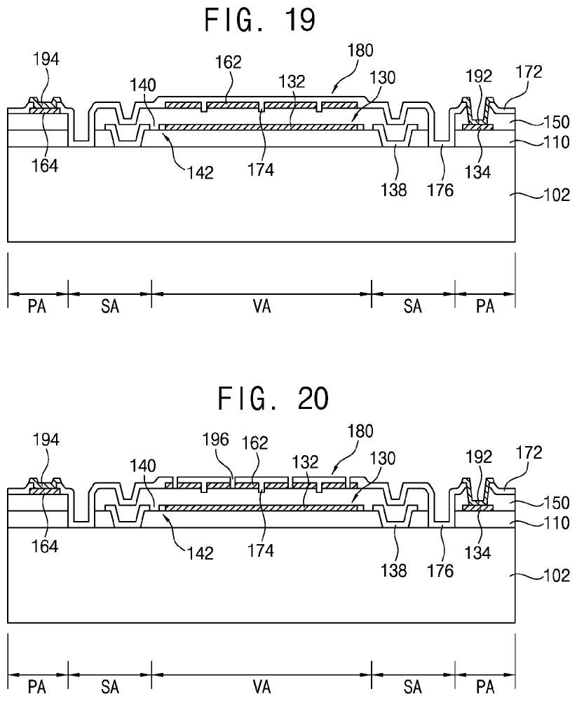

Referring to FIG. 19, a first bonding pad 192 and a second bonding pad 194 may be respectively formed on the first electrode pad 134 and the second electrode pad 164. For example, the first bonding pad 192 and the second bonding pad 194 may be made of a metal such as aluminum, and may be formed by forming an aluminum layer (not shown) on the support layer 172 and then patterning the aluminum layer.

Referring to FIG. 20, the support layer 172 and the second electrode layer 162 may be patterned to form a plurality of air holes 196. For example, after forming a photoresist pattern exposing portions where the air holes 196 are to be formed on the support layer 172, the air holes 196 may be formed by an anisotropic etching process using the photoresist pattern as an etching mask.

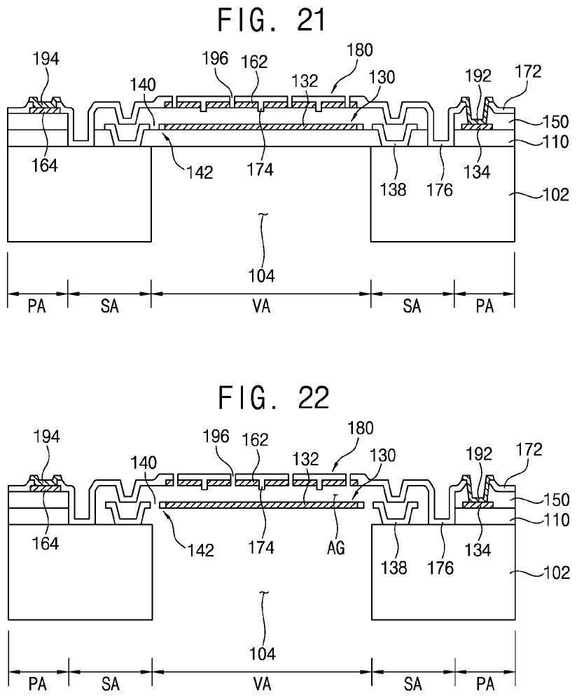

Referring to FIG. 21, a cavity 104 penetrating through the substrate 102 may be formed. For example, a back grinding process may be performed to reduce the thickness of the substrate 102, and then a cavity 104 penetrating the substrate 102 may be formed. In this case, the cavity 104 may be formed to correspond to the diaphragm 130 and to expose the first insulating layer 110 by an anisotropic etching process.

Referring to FIG. 22, an air gap (AG) may be formed by partially removing the first and second insulating layers 110 and 150. For example, a portion of the first insulating layer 110 and a portion of the second insulating layer 150 formed inside the second anchor portion 176 may be removed by an etching process. In such case, an etching solution or an etching gas may be supplied between the diaphragm 130 and the back plate 180 through the air holes 196 and the ventilation holes 140. As a result, the diaphragm 130 may be exposed downwardly through the cavity 104, and the air gap (AG) may be formed between the diaphragm 130 and the back plate 180.

Although the example embodiments of the present disclosure have been described with reference to the specific embodiments, they are not limited thereto. Therefore, it will be readily understood by those skilled in the art that various modifications and changes can be made thereto without departing from the spirit and scope of the present disclosure defined by the appended claims.

1. A MEMS (Micro Electro Mechanical System) microphone comprising:
a substrate having a cavity;
a diaphragm disposed above the substrate to correspond to the cavity; and
a back plate disposed above the diaphragm,
wherein the diaphragm has a plurality of ventilation holes, each of the ventilation holes comprises a plurality of slits, and the slits extend in a radial direction from a center of the each of the ventilation holes.

2. The MEMS microphone of claim 1, wherein when air pressure is applied to the diaphragm, portions of the diaphragm between the slits are bent by the air pressure so that a size of the ventilation holes is increased.

3. The MEMS microphone of claim 1, wherein the each of the ventilation holes further comprises a circular central hole, and the slits extend in the radial direction from the circular central hole.

4. The MEMS microphone of claim 1, wherein the slits have a triangular pyramid shape that gradually decreases in a width in the radial direction.

5. The MEMS microphone of claim 1, wherein the slits have a linear shape extending in the radial direction.

6. The MEMS microphone of claim 1, wherein the each of the ventilation holes further comprises end holes respectively connected to end portions of the slits.

7. The MEMS microphone of claim 1, wherein the each of the ventilation holes further comprises second slits respectively connected to end portions of the slits.

8. The MEMS microphone of claim 7, wherein the second slits have an arc shape, and the end portions of the slits are respectively connected to central portions of the second slits.

9. A MEMS (Micro Electro Mechanical System) microphone comprising:
a substrate comprising a vibration area, a support area surrounding the vibration area, and a periphery area surrounding the support area, and having a cavity formed through the vibration area;
a diaphragm disposed above the substrate to correspond to the cavity and having a plurality of ventilation holes; and
a back plate disposed above the diaphragm and having a plurality of air holes,
wherein each of the ventilation holes comprises a circular central hole and a plurality of slits extending in a radial direction from the circular central hole.

10. The MEMS microphone of claim 9, wherein the slits have a triangular pyramid shape that gradually decreases in a width in the radial direction.

11. The MEMS microphone of claim 9, wherein the slits have a linear shape extending in the radial direction.

12. The MEMS microphone of claim 9, wherein the each of the ventilation holes further comprises end holes respectively connected to end portions of the slits.

13. The MEMS microphone of claim 9, wherein the each of the ventilation holes further comprises second slits respectively connected to end portions of the slits.

14. The MEMS microphone of claim 13, wherein the second slits have an arc shape, and the end portions of the slits are respectively connected to central portions of the second slits.

15. The MEMS microphone of claim 9, wherein the diaphragm comprises:
a first electrode layer having a disk shape;
a ventilation region configured to surround the first electrode layer and through which the ventilation holes are formed; and
a first anchor portion configured to surround the ventilation region and configured to fix the diaphragm on the substrate.

16. The MEMS microphone of claim 15, wherein the first anchor portion is formed on the support area of the substrate.

17. The MEMS microphone of claim 15, wherein the back plate comprises:
a second electrode layer disposed above the first electrode layer to correspond to the first electrode layer; and
a support layer formed on the second electrode layer and configured to support the second electrode layer,
wherein the support layer comprises a second anchor portion configured to fix the support layer on the substrate.

18. The MEMS microphone of claim 17, wherein the second anchor portion is configured to surround the first anchor portion and is formed on the support area of the substrate.

19. The MEMS microphone of claim 17, further comprising:
a first insulating layer formed on the periphery area of the substrate;
a first electrode pad formed on the first insulating layer and electrically connected to the first electrode layer;
a second insulating layer formed on the first insulating layer and the first electrode pad; and
a second electrode pad formed on the second insulating layer and electrically connected to the second electrode layer.

20. The MEMS microphone of claim 19, further comprising:
a first bonding pad formed on the first electrode pad; and
a second bonding pad formed on the second electrode pad,
wherein an edge portion of the support layer is formed on the second insulating layer, the first bonding pad is connected to the first electrode pad through the edge portion of the support layer and the second insulating layer, and the second bonding pad is connected to the second electrode pad through the edge portion of the support layer.
